(19) United States
(12) Patent Application Publication
(10) Pub. No.: US 2008/0137910 A1
(43) Pub. Date: Jun. 12, 2008

(54) Locating method for locating a predetermined spot on a road and a locating apparatus using the method

(76) Inventors: Hanae Suzuki, Mizuho-shi (JP); Yumi Okamura, Mizuho-shi (JP)

Correspondence Address: MCDERMOTT WILL & EMERY LLP, 600 13TH STREET, N.W., WASHINGTON, DC, 20005-3096, US

(21) Appl. No.: 11/987,126

(22) Filed: Nov. 27, 2007

(30) Foreign Application Priority Data
Nov. 27, 2006 (JP) 2006-318307
Oct. 18, 2007 (JP) 2007-271403

(51) Int. Cl. G06K 9/00

(52) U.S. Cl. 382/104

(57) ABSTRACT

A picked-up image receiver receives a plurality of picked-up images taken by image pickup apparatuses provided in a plurality of positions on a road, respectively, via a wireless network. A reference image acquisition unit acquires a reference image to be compared respectively with the plurality of picked-up images received by the receiver, where reference image are taken by an image pickup apparatus installed in a vehicle. A matching processor locates at least one position on the road by performing pattern matching between the reference image acquired by the acquisition unit and each of the plurality of picked-up images received by the receiver.

### CROSS-REFERENCE TO RELATED APPLICATIONS

This application is based upon and claims the benefit of priority from the prior Japanese Patent Application No. 2006-318307, filed on Nov. 27, 2006 and Japanese Patent Application No. 2007-271403, filed on Oct. 18, 2007, the entire contents of which are incorporated herein by reference.

### BACKGROUND OF THE INVENTION

1. Field of the Invention

The present invention relates generally to a locating technology and, in particular, to a locating method for locating a specific point on the road and a locating apparatus and a system utilizing the same.

2. Description of the Related Art

An intelligent transport system (ITS), for instance, delivers information on an intersection via a wireless network to a vehicle running toward the intersection. In response, an in-vehicle unit equipped in the vehicle transmits its own ID to an intersection information delivery unit, and the intersection information delivery unit transmits relevant information to the ID as a target. Also, an intersection camera picks up an image of a license plate of a vehicle and delivers information to an in-vehicle unit ID which is uniquely determined from the picked-up number as a target.

When the in-vehicle unit receives delivered information from a plurality of intersections, it is necessary that the in-vehicle unit selects information from the closest intersection in the direction of travel accurately. For example, if IDs are given to all the actual intersections involved and their correspondence to the intersections on a map of a car navigation system is established in advance, then it is possible to locate an intersection on the map of the car navigation system from the ID of the intersection contained in the received information. A technology like this proves effective when the position of one's own vehicle is displayed accurately on the map of a car navigation system. In actual practice, however, the accuracy of the GPS (Global Positioning System) is only several meters, so that there can be errors, such as a vehicle running on an immaterial road or a road being matched to a wider road next door. If an in-vehicle unit receives delivered information under such circumstances, it is possible that the in-vehicle unit misconceives information from another intersection as one from the intersection it is now heading for.

Also, with a conventional technique, there needs to be one-to-one wireless communication between an intersection information delivery apparatus and each of the vehicles involved, so that at a busy intersection with congested vehicular traffic, it is difficult to achieve a smooth wireless communication between them using a limited communication band. Also, with such a conventional technique, a target cannot be located if a license plate of the vehicle is not visible to the intersection camera when, for instance, a small vehicle is behind a large vehicle, that is, it is in a blind spot. Such a conventional technique bases its operation on receiving information on an intersection that a vehicle is approaching and not receiving information on an intersection that it is leaving behind. Normally it does not take into consideration a possibility of mistakenly receiving information from an unrelated intersection.

### SUMMARY OF THE INVENTION

The present invention has been made in view of the foregoing circumstances, and a general purpose thereof is to provide a locating technology for accurately locating a specific point on a road, such as an intersection.

In order to achieve the above purpose, a locating apparatus according to one embodiment of the present invention comprises: a receiver which receives a plurality of picked-up images taken by image pickup apparatuses provided in a plurality of positions on a road, respectively, via a wireless network; an acquisition unit which acquires a reference image to be compared respectively with the plurality of picked-up images received by the receiver, the reference image having been taken by an image pickup apparatus installed in a vehicle; and a selector which performs pattern matching between the reference image acquired by the acquisition unit and each of the plurality of picked-up images received by the receiver so as to locate at least one position on the road.

According to this embodiment, positions and locations on the road are located by performing pattern matching between the picked-up images and the reference image. Thus, predetermined locations on the road, such as intersections, can be located with accuracy without relying on the memory of road information.

The receiver may receive a plurality of picked-up images taken by image pickup apparatuses provided at a plurality of intersections, respectively, wherein the plurality of intersections corresponds to the plurality of positions on the road; the acquisition unit may acquire the reference image from an image pickup apparatus for taking a rearward image from the vehicle, the image pickup apparatus corresponding to the image pickup apparatus installed in the vehicle; and the selector may perform pattern matching between a picked-up image of a view from the intersection in a direction of the vehicle out of the plurality of picked-up images and the reference image. In such case, the use of a picked-up image taken in the direction of the vehicle from an intersection enables the image pickup of the vicinity of the vehicle, and the short distance from the intersection to the vehicle can enhance the accuracy of pattern matching.

A plurality of intersections corresponds to the plurality of positions on the road, and the receiver may receive a combination of a picked-up image taken by an image pickup apparatus provided at a first intersection and a picked-up image taken by an image pickup apparatus provided at a second intersection adjacent to the first intersection; the acquisition unit may acquire a reference image from an image pickup apparatus for taking a forward image from the vehicle, the image pickup apparatus corresponding to the image pickup apparatus installed in the vehicle; and the selector may perform pattern matching between a picked-up image of a view in a direction from the second intersection toward the first intersection in the combination and the reference image so as to locate the first intersection. In such a case, the use of a picked-up image taken in the direction of the first intersection from the second intersection enables the image pickup of the vehicle, and the short distance from the intersection to the vehicle can enhance the accuracy of pattern matching.

The locating apparatus may further comprise a storage which stores an image of the vehicle in which the locating apparatus is provided, and the acquisition unit may acquire the reference image stored in the storage. In such a case, images of a vehicle are used as a reference image, so that a decision is made based on whether any image of the vehicle is picked up in the picked-up images. Hence an improved accuracy of location can be achieved.

The locating apparatus may further comprise a display which displays a picked-up image in the intersection located by the selector. In such a case, the information on intersections can be communicated to a vehicle's driver.

Another embodiment of the present invention relates also to a locating apparatus. This apparatus comprises: a receiver which receives a plurality of picked-up images taken by image pickup apparatuses provided in a plurality of positions on a road, respectively, via a wireless network; an acquisition unit which acquires a reference image to be compared respectively with the plurality of picked-up images received by the receiver, the reference image having been taken by an image pickup apparatus installed in a vehicle; and a selector which locates at least one position on the road, based on information contained in the reference image acquired by the acquisition unit and information associated with each of the plurality of picked-up images received by the receiver.

By employing this embodiment, the positions and locations on the road are located based on the information associated with the picked-up images and the information contained in the reference image. Thus, predetermined locations on the road, such as intersections, can be located with accuracy without relying on the memory of road information.

Still another embodiment of the present invention relates to a locating system. This locating system comprises: a plurality of image pickup apparatuses provided in a plurality of positions on a road, respectively; and a locating apparatus connected, via a wireless network, to the image pickup apparatuses provided in a plurality of positions on a road. The locating apparatus locates at least one position on the road by performing pattern matching between each of a plurality of images received from the plurality of image pickup apparatuses and a reference image picked up by an image pickup apparatus installed in a vehicle.

Still another embodiment of the present invention relates also to a locating system. This locating system comprises: a plurality of image pickup apparatuses provided in a plurality of positions on a road, respectively; and a locating apparatus connected, via a wireless network, to the image pickup apparatuses provided in a plurality of positions on a road. The locating apparatus locates at least one position on the road, based on a plurality of pieces of information contained in a plurality of picked-up images received from the plurality of image pickup apparatuses, respectively, and information contained in a reference image picked up by an image pickup apparatus installed in a vehicle.

Still another embodiment of the present invention relates to a locating method. This method is such that a plurality of picked-up images taken by image pickup apparatuses provided in a plurality of positions on a road, respectively, are received via a wireless network, a reference image taken by an image pickup apparatus installed in a vehicle is acquired, and pattern matching is performed between each of the plurality of picked-up images and the reference so as to locate at least one position on the road.

A plurality of picked-up images taken by image pickup apparatuses provided at a plurality of intersections, respectively, are received as the plurality of positions on the road; the reference image may be acquired from an image pickup apparatus for taking a rearward image from the vehicle, as the image pickup apparatus installed in the vehicle; and pattern matching may be performed between a picked-up image of a view from the intersection in a direction of the vehicle out of the plurality of picked-up images and the reference image.

A plurality of intersections may correspond to the plurality of positions of interest on the road, and a combination of a picked-up image taken by an image pickup apparatus provided at a first intersection and a picked-up image taken by an image pickup apparatus provided at a second intersection adjacent to the first intersection may be received; a reference image may be acquired from an image pickup apparatus for taking a forward image from the vehicle, as the image pickup apparatus installed in the vehicle; and the first intersection may be located by performing pattern matching between a picked-up image of a view in a direction from the second intersection toward the first intersection in the combination and the reference image. An image of the vehicle may be acquired as a reference image. A display for displaying a picked-up image in the located intersection may be further provided.

Still another embodiment of the present invention relates also to a locating method. This method is such that a plurality of picked-up images taken by image pickup apparatuses provided in a plurality of positions on a road, respectively, are received via a wireless network, a reference image taken by an image pickup apparatus installed in a vehicle is acquired, and at least one position on the road is located, based on information associated with each of the plurality of picked-up images and information contained in the reference image.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 illustrates a structure of a locating system according to an exemplary embodiment of the present invention;

FIG. 2 illustrates a structure of an intersection A camera shown in FIG. 1;

FIG. 3 illustrates a structure of a car navigation apparatus shown in FIG. 1;

FIGS. 4A to 4D illustrate picked-up images and a reference image, which are the subjects of processing by a matching processor shown in FIG. 3;

FIG. 5 illustrates images displayed by a display shown FIG. 3;

FIG. 6 is a sequence diagram showing a delivery procedure for a combination of picked-up images taken by intersection A cameras shown in FIG. 1;

FIG. 7 is a sequence diagram showing a display procedure for picked-up images taken in a locating system shown in FIG. 1;

FIG. 8 is a flowchart showing a delivery procedure for a combination of picked-up images by a first intersection A camera shown in FIG. 6;

FIG. 9 is a flowchart showing a display procedure for picked-up images by a car navigation apparatus shown in FIG. 3;

FIG. 10 illustrates a structure of a locating system according to a modification of an exemplary embodiment;

FIG. 11 is a sequence diagram showing a delivery procedure for a combination of picked-up images taken by intersection A cameras and intersection B cameras shown in FIG. 10;

FIG. 12 is a flowchart showing a delivery procedure for a combination of picked-up images by an intersection A camera shown in FIG. 11;

FIG. 13 illustrates a structure of a car navigation apparatus according to another modification of an exemplary embodiment;

FIG. 14 is a flowchart showing a display procedure for picked-up images by a car navigation apparatus shown in FIG. 13;

FIG. 15 illustrates a structure of a locating system according to still another modification of an exemplary embodiment;

FIG. 16 is a flowchart showing a deduction procedure for the presence of a large vehicle by still another modification of an exemplary embodiment;

FIG. 17 is a flowchart showing a display procedure for picked-up images according to still another modification of an exemplary embodiment; and

FIG. 18 is a flowchart showing a display procedure for picked-up images according to still another modification of an exemplary embodiment.

### DETAILED DESCRIPTION OF THE INVENTION

The invention will now be described by reference to the preferred embodiments. This does not intend to limit the scope of the present invention, but to exemplify the invention.

The present invention will now be outlined before it is described in detail. Exemplary embodiments of the present invention relate to a locating system which comprises a car navigation apparatus (hereinafter referred to as “car-navi apparatus” also) installed in a vehicle and a camera installed outside the vehicle, e.g., at an intersection (hereinafter referred to as an “intersection camera”). An intersection camera installed at each intersection picks up images that can be used to grasp the condition of the intersection. For example, it takes images that show the condition of a plurality of roads branching off from the intersection. Also, the intersection camera delivers picked-up images as intersection information or delivered information. A car navigation apparatus receives intersection information from each of a plurality of intersection cameras. Also, an on-vehicle camera is installed in a rear part of a vehicle, and this on-vehicle camera captures rearward views as reference images. The car navigation apparatus performs pattern matching between the picked-up images contained in a plurality of pieces of intersection information and a reference image and thereby identifies a specific piece of intersection information and at the same time displays the picked-up image contained in the intersection information. Note that in the following description, the picked-up image and the reference image are both still images for the clarity of explanation. They may be moving images as well.

The terms used in the present exemplary embodiment are as follows. “Intersection information” is information designed mainly to support safety at an intersection. The intersection information includes images to be expected after a right turn and a left turn, respectively, and a picked-up image and is delivered within the neighborhood of the intersection. Using this intersection information, a driver of a vehicle approaching the intersection can gain prior knowledge of the condition of the intersection out of his/her line of vision. “Delivered information” is intersection information delivered from a transmitter or an intersection camera installed near the intersection. Note that in the following description, it is not necessary to make a clear distinction between “intersection information” and “delivered information”.

An “intersection camera” is installed on a traffic signal at an intersection or the like and picks up a condition in and around the intersection. As mentioned above, the intersection camera may have a delivery function of intersection information. An “in-vehicle unit” is an equipment that receives, analyzes and displays intersection information. It is represented by a car navigation apparatus in the following description. An “on-vehicle camera” is mounted on a vehicle and captures images of the condition outside of the vehicle. The on-vehicle camera is installed on the interior or the exterior of a vehicle and is equivalent to a camera for a rearview monitor, for instance.

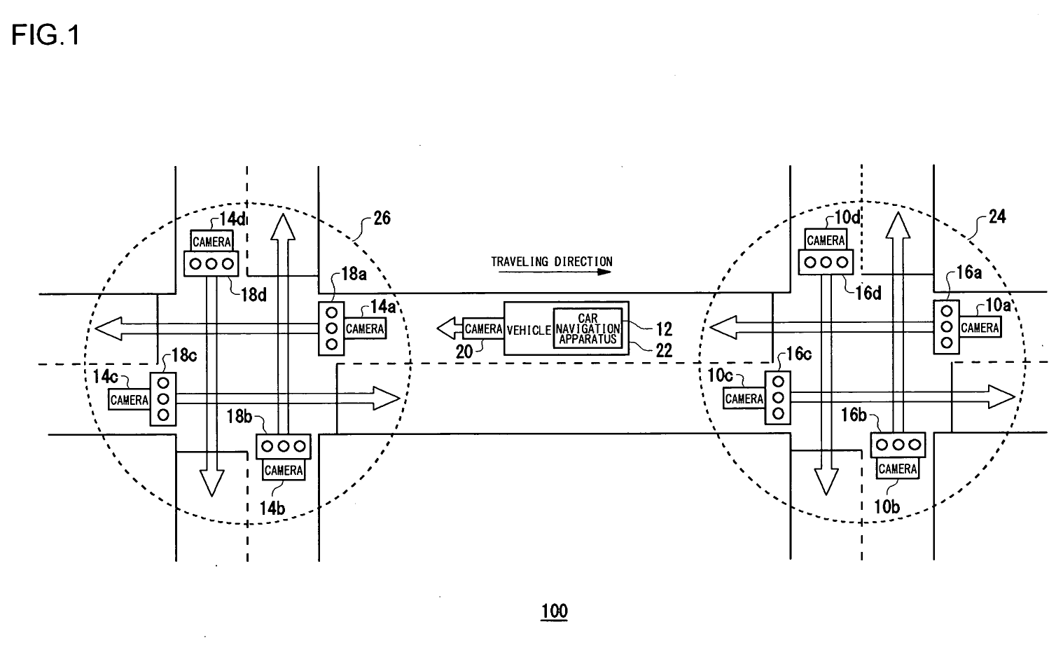

FIG. 1 illustrates a structure of a locating system 100 according to an exemplary embodiment of the present invention. The locating system 100 includes a first intersection A camera 10a, a second intersection A camera 10b, a third intersection A camera 10c, and a fourth intersection A camera 10d (these four cameras collectively referred to as “intersection A cameras 10”), a car navigation apparatus 12, a first intersection B camera 14a, a second intersection B camera 14b, a third intersection B camera 14c, and a fourth intersection B camera 14d (these four cameras collectively referred to as “intersection B cameras 14”), and an on-vehicle camera 20.

FIG. 1 also illustrates, as an example, intersection A 24 and intersection B 26. Installed at intersection A 24 are a first intersection A traffic signal 16a, a second intersection A traffic signal 16b, a third intersection A traffic signal 16c, and a fourth intersection A traffic signal 16d (these four traffic signals collectively referred to as intersection A traffic signals 16), and installed at intersection B 26 are a first intersection B traffic signal 18a, a second intersection B traffic signal 18b, a third intersection B traffic signal 18c, and a fourth intersection B traffic signal 18d (these four traffic signals collectively referred to as intersection B traffic signals 18). A vehicle 22 is running on a road leading from the intersection B 26 to the intersection A 24. And installed on the vehicle 22 are an on-vehicle camera 20 and a car navigation apparatus 12.

Also, the intersection A cameras 10 are installed at the intersection A traffic signals 16, respectively, and the intersection B cameras 14 are installed at the intersection B traffic signals 18, respectively. Note that the intersection A cameras 10 and the intersection B cameras 14 are equivalent to the aforementioned “intersection cameras”. Although there are intersections other than the intersection A 24 and the intersection B 26, these two intersections are used herein for the simplicity of explanation. The intersection A cameras 10, the intersection B cameras 14 and the on-vehicle camera 20 pick up their respective images in the direction of the arrows as indicated in FIG. 1.

The intersection A cameras 10 pick up their respective images in the directions different from one another. As illustrated in FIG. 1, the vehicle 22 is traveling to the right. Therefore, the driver of the vehicle 22 needs information on the intersection A 24, not information on the intersection B 26. Of the four intersection A cameras 10 installed at the intersection A 24, the first intersection A camera 10a takes images in the direction of the vehicle 22, the second intersection A camera 10b takes images in the direction of a left turn for the vehicle 22, and the fourth intersection A camera 10d takes images in the direction of a right turn for the vehicle 22. Further, the third intersection A camera 10c takes images in the direction of travel of the vehicle 22.

These picked-up images are brought together to the first intersection A camera 10a by communication via a wireless network. For example, the second intersection A camera 10b transmits the picked-up images to the first intersection A camera 10a. And the first intersection A camera 10a generates information to be delivered by combining such picked-up images together. That is, the images delivered not only show picked-up images that allow the driver of the vehicle 22 to see the conditions to be expected after a right turn, a left turn and a travel forward, but also include a picked-up image in the direction of the vehicle 22 now heading toward the intersection A 24. Also, the intersection B cameras 14 installed at the intersection B traffic signals 18 operate in the similar manner to the intersection A cameras 10. And these intersection cameras are installed at a plurality of locations on the road, for instance, at every intersection.

The car navigation apparatus 12 installed in the vehicle 22 receives information delivered from such an information-delivering intersection camera as it travels through an information delivery area of such an intersection camera. When the distance between intersections is short, the information delivery areas of a plurality of intersection cameras may overlap each other. In such a case, the car navigation apparatus 12 receives delivered information from both the first intersection A camera 10a and the first intersection B camera 14a. In other words, the car navigation apparatus 12 is connected to intersection cameras installed at a plurality of locations on the road via a wireless network. It should be noted here that the radio communication scheme used for the wireless network between the car navigation apparatus 12 and the intersection cameras and the one used between the aforementioned intersection A cameras 10 may be the same or different from each other.

Also, an on-vehicle camera 20 is installed in the rear part of the vehicle 22, and this on-vehicle camera 20 captures the images of rearward views of the vehicle 22 (hereinafter referred to as “reference images”). It is to be noted that the direction of the vehicle 22 as seen from the first intersection A camera 10a is the same as the rearward direction from the vehicle 22. Therefore, the images picked up by the first intersection A camera 10a and the reference images contain the same objects such as buildings. Thus the car navigation system performs pattern matching between a picked-up image and a reference image. If the result of the matching presents a value greater than or equal to a predetermined threshold value, then the car navigation apparatus 12 in the vehicle 22 will decide that the intersection camera having taken the picked-up image belongs to an intersection of interest and displays the delivered information containing the picked-up image. That is, the intersection A 24 is now located. Note that the process as described above is performed for the delivered information received from the first intersection B camera 14a as well.

Note also that the car navigation apparatus 12 may display the result of matching, which is an image facing the direction opposite to the direction of travel. If necessary, the reference image may be inverted before the pattern matching is performed. This is because an image showing a rearview is normally used to display a rearward condition when the vehicle is put in reverse and is often inverted the same way as an image in a rearview mirror.

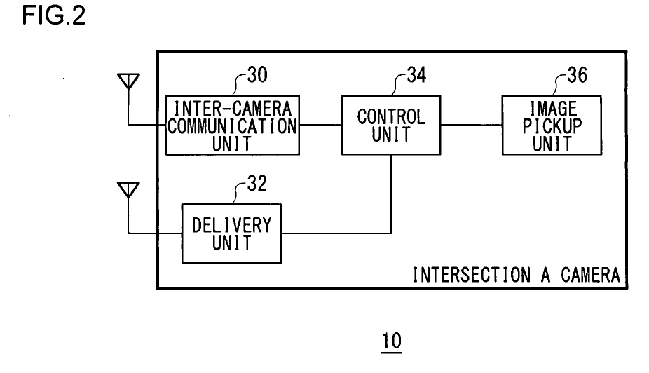

FIG. 2 illustrates a structure of an intersection A camera 10. The intersection A camera 10 includes an inter-camera communication unit 30, a delivery unit 32, a control unit 34, and an image pickup unit 36. Other intersection cameras, such as an intersection B camera 14, have a similar structure.

The image pickup unit 36 picks up images. The direction of image pickup by the image pickup unit 36 is as shown in FIG. 1. The inter-camera communication unit 30 transmits images picked up by the image pickup unit 36 to the other intersection A cameras and receives images picked up by the other intersection A cameras A. Note that the inter-camera communication unit 30 is compatible with a wireless system, such as a wireless LAN (Local Area Network). Here, for the clarity of explanation, it is assumed that the picked-up images are gathered to one of the four intersection A cameras 10, namely, the first intersection A camera 10a. Hence, the inter-camera communication unit 30 of the first intersection A camera 10a performs its receiving function, whereas the inter-camera communication units 30 of the second to fourth intersection A cameras 10b to 10d perform their transmission function. Note that the transmission can be made either in unicast or multicast.

The control unit 34 controls the operation of the intersection A cameras 10. For example, the control units 34 of the second to fourth intersection A cameras 10b to 10d output the images picked up by the respective image pickup units 36 to the respective inter-camera communication units 30. Also, the control unit 34 of the first intersection A cameras 10a generates information to be delivered from a combination of an image picked up by the image pickup unit 36 and the images picked up by the inter-camera communication unit 30. In other words, the image pickup unit 36 combines the images picked up by the first to fourth intersection A cameras 10a to 10d, respectively. Here, the image pickup unit 36 may generate a panoramic image by synthesizing a plurality of picked-up images. Also, the control unit 34 may add information for locating the intersection A 24 to the information to be delivered.

The delivery unit 32 delivers information to be delivered, which is generated at the control unit 34, to a not-shown car navigation apparatus 12 via a wireless network. Note that as mentioned already, the wireless network may be the same as or different from the wireless network for the inter-camera communication unit 30. Also, the delivery of information is done by multicast or broadcast. The directivity of the delivery unit 32 may be predetermined, but it is assumed to be nondirectional herein.

This structure may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

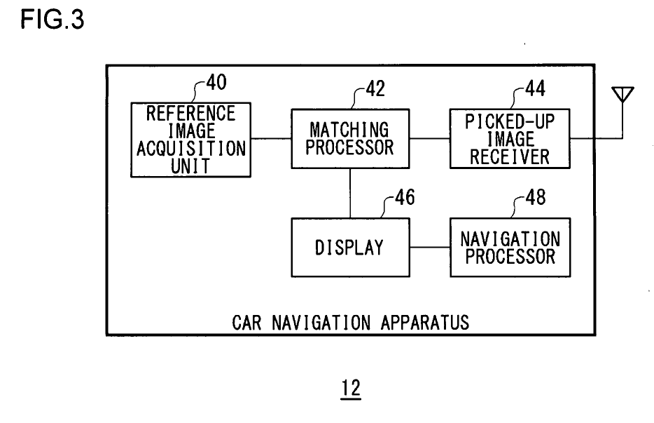

FIG. 3 illustrates a structure of a car navigation apparatus 12. The car navigation system 12 includes a reference image acquisition unit 40, a matching processor 42, a picked-up image receiver 44, a display 46, and a navigation processor 48.

The picked-up image receiver 44 receives delivered information from not-shown intersection cameras, for instance, the intersection A cameras 10 and the intersection B cameras 14, via a wireless network. Since the delivered information contains picked-up images, this receiving is equivalent to the receiving of images picked up respectively by intersection cameras installed at a plurality of locations on the road. Also, the plurality of locations on the road are equivalent to a plurality of intersections, for instance, the intersection A 24 and the intersection B26 as shown in FIG. 1. Here, it is also assumed that the wireless communication is of the same scheme as that that for the delivery unit 32 in FIG. 2. The picked-up image receiver 44 outputs delivered information thus received to the matching processor 42.

The reference image acquisition unit 40 acquires a reference image to be compared with each of the plurality of picked-up images out of the delivered information received by the picked-up image receiver 44. The reference image acquisition unit 40 acquires the reference image from the on-vehicle camera 20 as shown in FIG. 1. That is, the reference image is picked up by the on-vehicle camera 20 installed on the vehicle 22 as shown in FIG. 1. In this setup, the on-vehicle camera 20 captures a rearview image from the vehicle 22. The reference image acquisition unit 40 outputs the reference image thus acquired to the matching processor 42.

The matching processor 42 performs pattern matching between each of the plurality of picked-up images out of the delivered information received by the picked-up image receiver 44 and a reference image acquired by the reference image acquisition unit 40. In particular, the matching processor 42 carries out pattern matching of a picked-up image of a view from the intersection in the direction of the vehicle out of the plurality of picked-up images, namely, a picked-up image taken by the first intersection A camera 10a in FIG. 1, with the reference image. The pattern matching may be done using any known art. For example, the matching processor 42 extracts feature points of a picked-up image by analyzing it and compares the feature points thereof against those of the reference image.

The pattern matching may also be done by other methods. For example, without the use of extraction of feature points, the pixel values of a picked-up image and those of a reference image may be compared with each other. If the result of the matching presents a value greater than or equal to a predetermined threshold value, that is, if there is a significant level of correlation between the reference image and a picked-up image, then the matching processor 42 will decide that the intersection camera having taken the picked-up image now under consideration belongs to an intersection of interest and thus locates at least one location on the road.

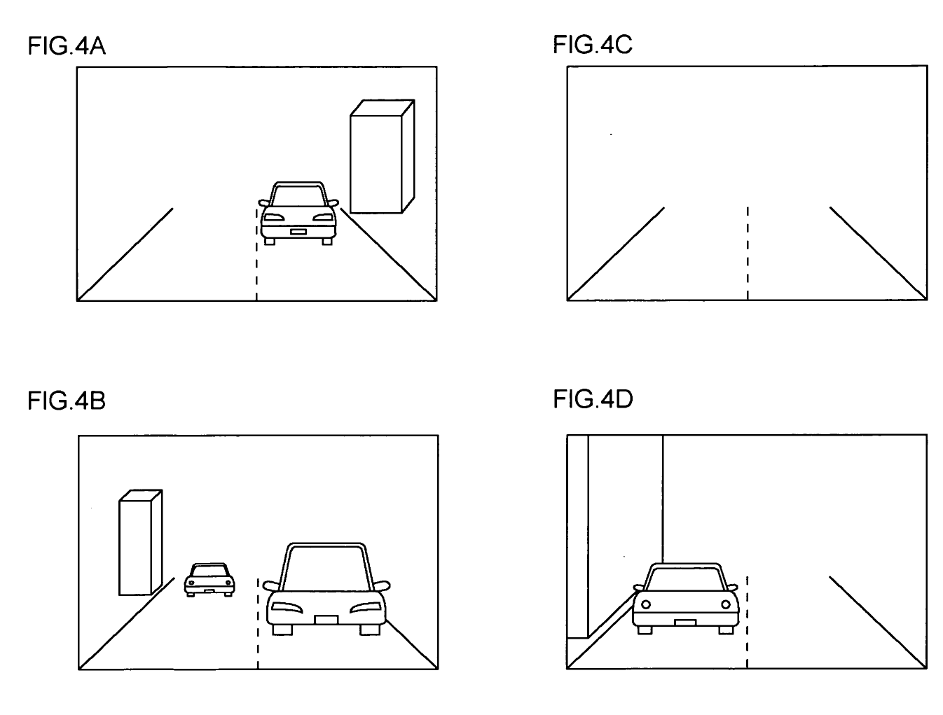

A description will now be given of a processing by a matching processor 42 with a concrete example. FIGS. 4A to 4D illustrate picked-up images and a reference image, which are the subjects of processing by the matching processor 42. FIGS. 4A to 4C represent picked-up images contained in a piece of delivered information, whereas FIG. 4D represents a reference image. FIG. 4A shows a picked-up image taken by the fourth intersection A camera 10d in FIG. 1, namely, a picked-up image in the direction of a right turn for the vehicle 22. FIG. 4B shows a picked-up image taken by the first intersection A camera 10a in FIG. 1, namely, a picked-up image in the rearward direction for the vehicle 22.

FIG. 4C shows a picked-up image taken by the second intersection A camera 10b in FIG. 1, namely, a picked-up image in the direction of a left turn for the vehicle 22. FIG. 4D is a reference image taken by the on-vehicle camera 20 in FIG. 1. As previously described, the matching processor 42 carries out the above-mentioned locating based on the result of matching between FIG. 4B and FIG. 4D. Note, however, that the matching processor 42 also performs matching of FIG. 4A and FIG. 4C against the reference image in order to select FIG. 4B. Now refer back to FIG. 3.

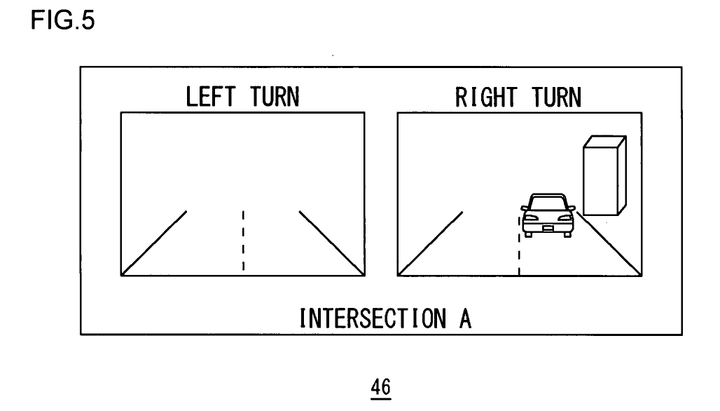

A display 46, which is comprised of a display screen, displays picked-up images taken at the intersection located by the matching processor 42 when the display mode is an image mode. Note that the display 46 may also display a matching ratio, or a level of reliability. Also, the display 46 displays a result of navigation by the navigation processor 48 or map information when the display mode is a navigation mode. The navigation processing like this is performed by the navigation processor 48, and the description thereof is omitted here because it can be performed by known art. FIG. 5 illustrates images displayed by the display 46. The display 46 displays picked-up images corresponding to a left turn and a right turn, respectively, out of the delivered information on the intersection located by the matching processor 42. The picked-up image for a left turn is equal to FIG. 4C, and the picked-up image for a right turn is equal to FIG. 4A.

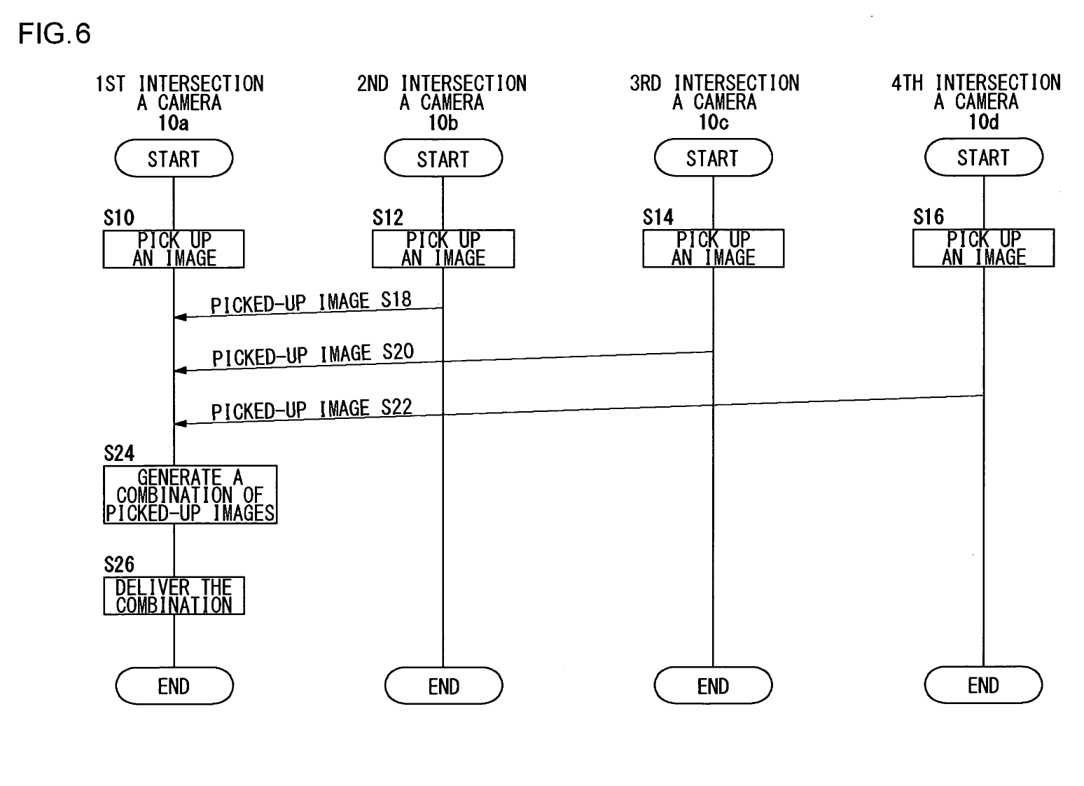

A description will now be given of an operation of the locating system 100 implementing the structure as described above. FIG. 6 is a sequence diagram showing a delivery procedure for a combination of picked-up images taken by intersection A cameras 10. The first to fourth intersection A cameras 10a to 10d take their respective picked-up images (S10 to S16). The second to fourth intersection A cameras 10b to 10d transmit their respective picked-up images to the first intersection A camera 10a (S18 to S22). The first intersection A camera 10a generates a combination of the picked-up images as information to be delivered (S24). The first intersection A camera 10a delivers the combined information (S26).

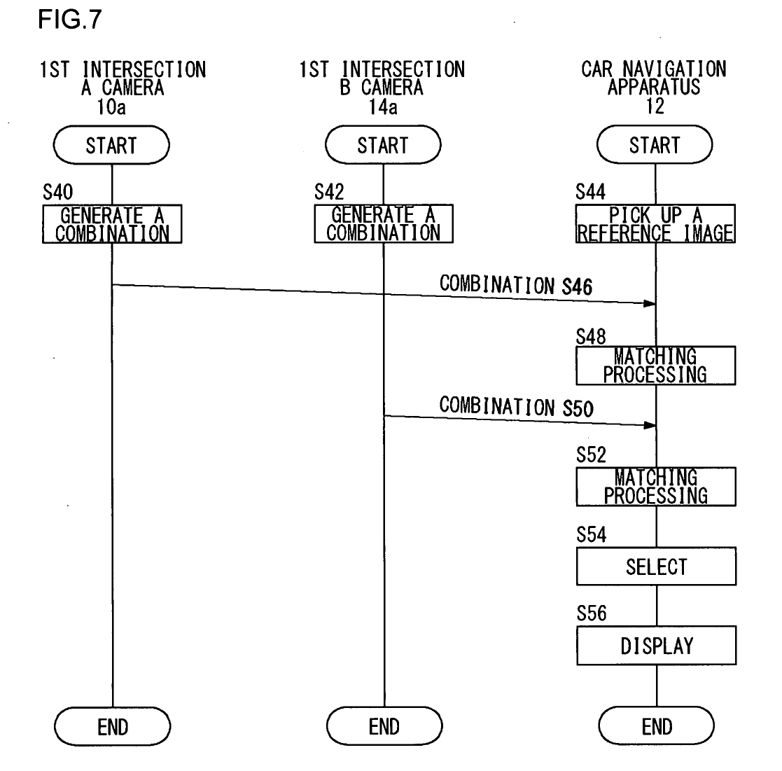

FIG. 7 is a sequence diagram showing a display procedure for picked-up images taken in a locating system 100. The first intersection A camera 10a and the first intersection B camera 14a generate their respective combinations of images (S40, S42). The car navigation apparatus 12 picks up a reference image (S44). The first intersection A camera 10a delivers its combination of images to the car navigation apparatus 12 (S46). The car navigation apparatus 12 performs a pattern matching processing on the combination of images and the reference image (S48). The first intersection B camera 14a delivers its combination of images to the car navigation apparatus 12 (S50). The car navigation apparatus 12 performs a pattern matching processing on the combination of images and the reference image (S52). As a result of the pattern matching processing, the car navigation apparatus 12 selects the combination of images received from the first intersection A camera 10a (S54). The car navigation apparatus 12 displays picked-up images included in the selected combination of images (S56).

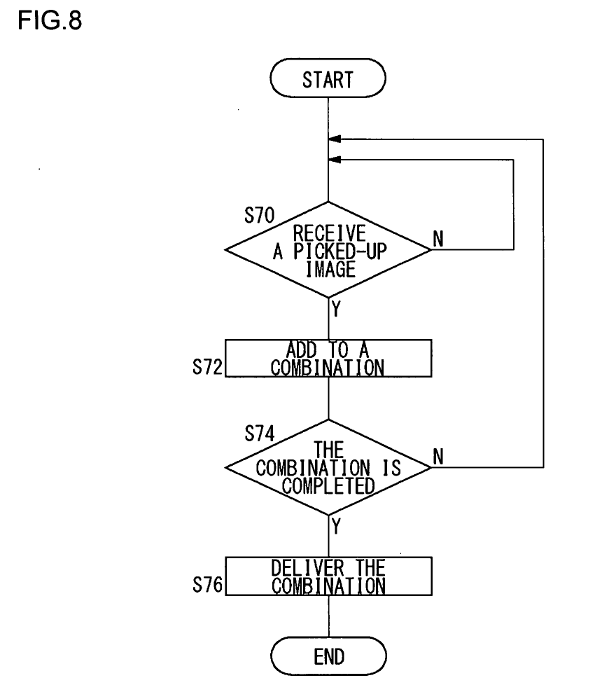

FIG. 8 is a flowchart showing a delivery procedure for a combination of picked-up images by the first intersection A camera 10a. When the inter-camera communication unit 30 does not receive any picked-up image (N of S70), the control unit 34 remains on standby. When the inter-camera communication unit 30 receives a picked-up image (Y of S70), the control unit 34 adds the picked-up image to a combination of picked-up images (S72). If the combination of images is not completed (N of S74), a return is made to Step 70. On the other hand, if the combination of images is completed (Y of S74), the delivery unit 32 will deliver the combination of images (S76).

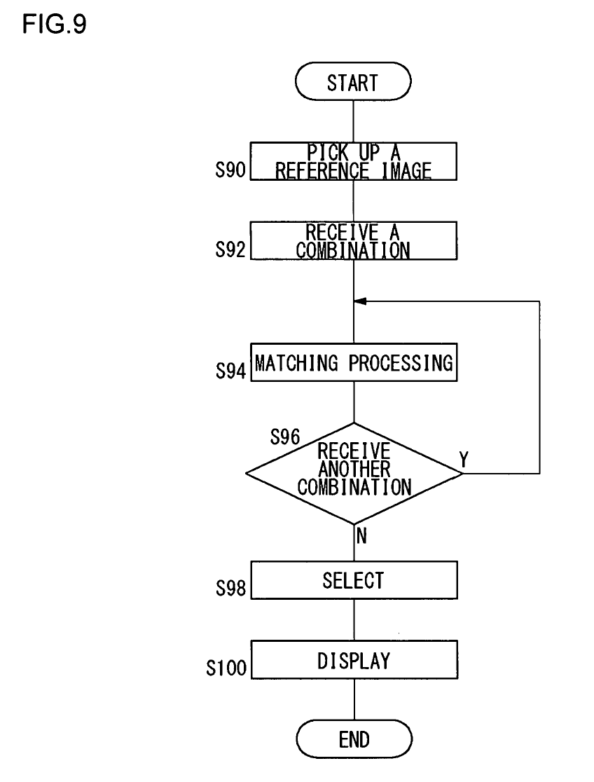

FIG. 9 is a flowchart showing a display procedure for picked-up images by the car navigation apparatus 12. The reference image acquisition unit 40 acquires a reference image picked up by the on-vehicle camera 20 (S90). The picked-up image receiver 44 receives a combination of images (S92). The matching processor 42 performs a pattern matching processing on the combination of images and the reference signal (S94). If the picked-up image receiver 44 receives another combination of images (Y of S96), a return will be made to Step 94. If the picked-up image receiver 44 does not receive another combination of images (N of S96), the matching processor 42 will select one combination of images based on the result of pattern matching (S98). The display 46 displays picked-up images included in the selected combination of images (S100).

Now a modification of the present exemplary embodiments is described. In the exemplary embodiments so far described, the reference image is a rearward image taken from the rear part of a vehicle. Accordingly, a picked-up image to become the subject of pattern matching is the one of a view from the intersection in the direction of the vehicle 22. In this modification, however, the reference image is one of a forward view taken from the front part of the vehicle. Accordingly, a picked-up image to become the subject of pattern matching is the one of a view in the direction of the vehicle 22 from the intersection behind the vehicle 22. In other words, between the embodiment and this modification thereof, the reference images are different, so that the picked-up images to become the subject of pattern matching are also different.

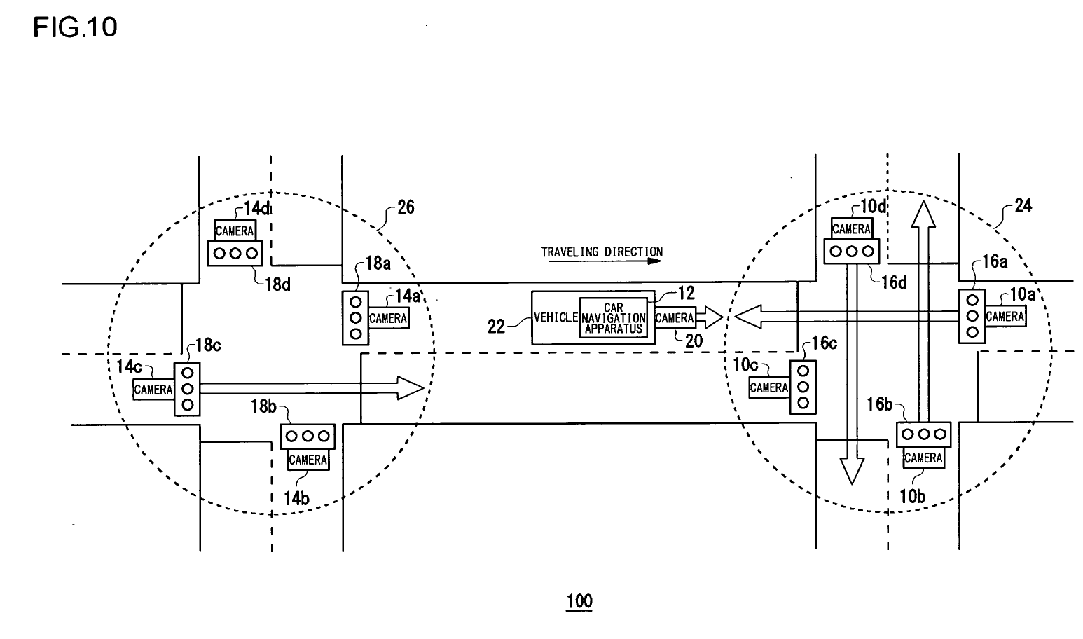

FIG. 10 illustrates a structure of a locating system 100 according to a modification of the exemplary embodiment. The description of the constituent features of FIG. 10 is omitted because they are the same as those of FIG. 1. And for the clarity of explanation, the arrows shown to indicate the directions of image pickup by the intersection A cameras 10 and the intersection B cameras 14 are only those necessary for the description. The same way as with the exemplary embodiment, delivered information corresponding to the intersection A 24 is delivered from the first intersection A camera 10a. Note also that the delivered information according to the exemplary embodiment contains picked-up images taken respectively by the intersection A cameras 10.

On the other hand, included in the delivered information according to the present modification is a picked-up image taken by the third intersection B camera 14c, in addition to the picked-up images taken by the intersection A cameras 10. In other words, a picked-up image taken by an intersection camera installed at an intersection adjacent to the intersection now under consideration is included. Note that a picked-up image taken by the third intersection B camera 14c is equal to a picked-up image taken in the direction of the vehicle 22 from an intersection camera located on the side opposite to the direction of travel of the vehicle 22. Hence, without an obstruction, the picked-up image shows the rear part of the vehicle 22.

The intersection A cameras 10 and the intersection B cameras 14 in this modification may be of the same structural type as the one shown in FIG. 2. Note that the inter-camera communication unit 30 of the third intersection B camera 14c transmits a picked-up image taken by the image pickup unit 36 to the first intersection A camera 10a. And the inter-camera communication unit 30 of the first intersection A camera 10a receives the picked-up image from the third intersection B camera 14c. The control unit 34 generates information to be delivered by adding the picked-up image from the third intersection B camera 14c.

The on-vehicle camera 20, which is installed in the front part of the car navigation apparatus 12, picks up forward images. The car navigation apparatus 12 performs a pattern matching between picked-up images contained in delivered information and a reference image taken by the on-vehicle camera 20 the same way as in the exemplary embodiment. Where the delivered information is one delivered from the first intersection A camera 10a, a pattern matching is done between the picked-up image taken by the third intersection B camera 14c and the reference image. Except for the difference in the image used, the processing in this modification is the same as that of the exemplary embodiment.

The car navigation apparatus 12 in this modification is of the same structural type as the one shown in FIG. 3. The reference image acquisition unit 40 receives delivered information. As mentioned above, the delivered information contains a combination of the picked-up images taken by the intersection A cameras 10 installed at the intersection A 24 and the picked-up image taken by an intersection B camera 14 installed at the intersection B 26 located next to the intersection A 24. The on-vehicle camera 20 acquires a reference image from the vehicle 22 which is to pick up forward images therefrom. The matching processor 42 locates the intersection A 24 by performing a pattern matching between the picked-up image taken by the third intersection B camera 14c out of a combination of images and the reference image.

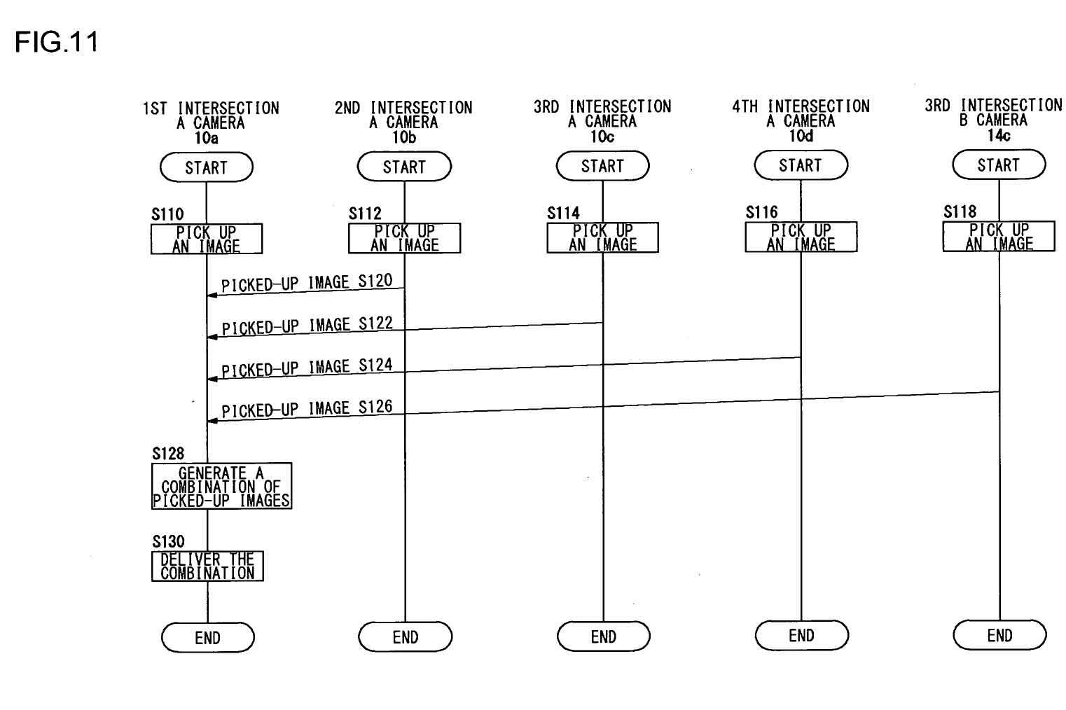

A description will now be given of an operation of the locating system 100 implementing the structure of this modification. FIG. 11 is a sequence diagram showing a delivery procedure for a combination of picked-up images taken by intersection A cameras 10 and intersection B cameras 14. The first to fourth intersection A cameras 10a to 10d and the third intersection B camera 14c take their respective picked-up images (S110 to S118). The second to fourth intersection A cameras 10b to 10d and the third intersection B camera 14c transmit their respective picked-up images to the first intersection A camera 10a (S120 to S126). The first intersection A camera 10a generates a combination of the picked-up images as information to be delivered (S128). The first intersection A camera 10a delivers the combined information (S130).

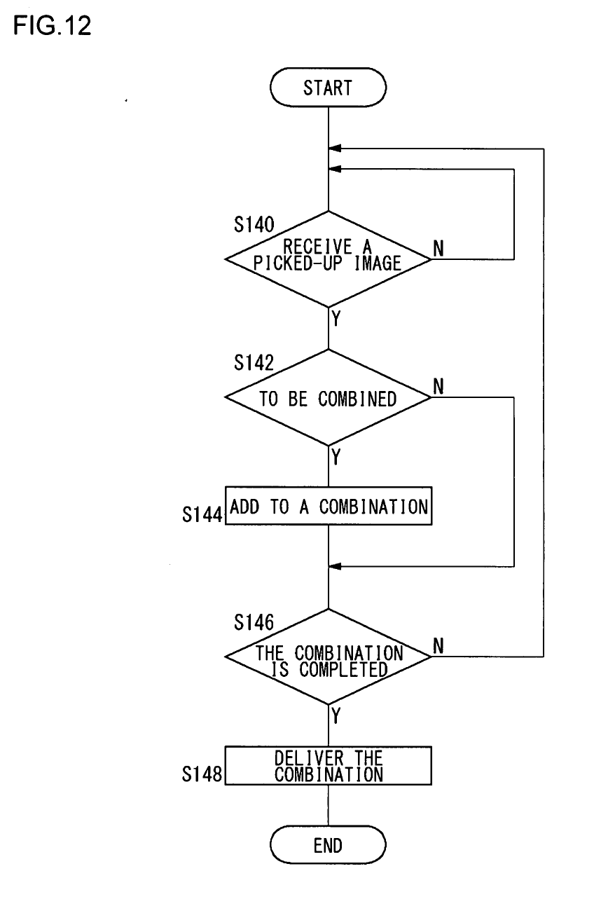

FIG. 12 is a flowchart showing a delivery procedure for a combination of picked-up images by an intersection A camera 10. If the inter-camera communication unit 30 does not receive any picked-up image (N of S140), the control unit 34 will remain on standby. If the inter-camera communication unit 30 receives a picked-up image (Y of S140) and also if the picked-up image is the subject of combination (Y of S142), the control unit 34 will add the picked-up image to a combination of picked-up images (S144). Or if the picked-up image is not the subject of combination (N of S142), the control unit 34 will skip the processing of Step 144. Now if the combination of images is not completed (N of S146), a return will be made to Step 140. On the other hand, if the combination of images is completed (Y of S146), the delivery unit 32 will deliver the combination of images (S148).

Now another modification of the present embodiment is described. In the embodiments so far described, delivered information is selected based on the result of pattern matching. According another modification, however, traffic signals are provided with their respective identification information which differ from each other, and each of the traffic signals performs a modulation according the identification information when it lights up. Also, the delivered information contains the identification information. The car navigation apparatus 12 extracts not only the identification information attached to the delivered information but also the identification information from the reference image. When the two agree with each other, the car navigation apparatus 12 locates the intersection of interest and displays the picked-up images corresponding to the thus located intersection.

A locating system 100 according to the another modification is of the same type as one of FIG. 10. The intersection A traffic signals 16 installed at the intersection A 24 and the intersection B traffic signals 18 installed at the intersection B 26 give signals by blinking the red, blue and yellow indicating lamps at a rapid rate. This blinking, which is so rapid as to be imperceptible to the human eye, is equivalent to signals modulated according to the identification information. The intersection A cameras 10, the intersection B cameras 14, and the on-vehicle camera 20 perform image pickup in such a manner that the information includes the intersection A traffic signals 16 or the intersection B traffic signals 18. The first intersection A camera 10a adds the identification information of a signal to the information to be delivered.

The on-vehicle camera 20 installed in the vehicle 22 picks up a reference image as it faces forward. And the car navigation apparatus 12 extracts a traffic signal picked up in the reference image and reads the identification number indicated by the traffic signal. The car navigation apparatus 12 receives delivered information and displays it if the identification number contained therein agrees with the identification number it has read directly. That is, the car navigation apparatus 12 locates an intersection based on the identification information associated respectively with a plurality of picked-up images and the information contained in a reference image.

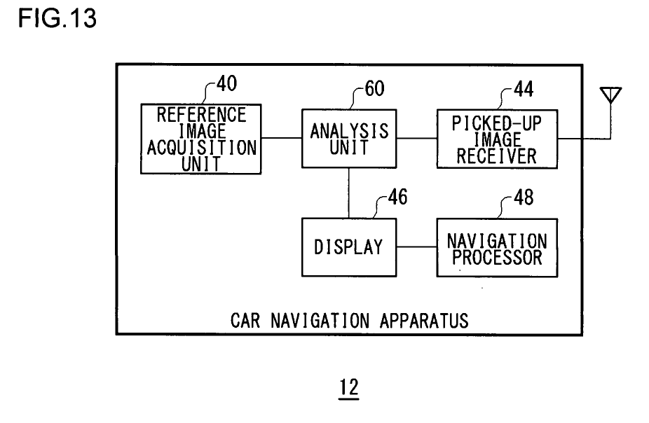

FIG. 13 shows a structure of a car navigation apparatus 12 according to the another modification of the exemplary embodiment. The car navigation apparatus 12 includes a reference image acquisition unit 40, a picked-up image receiver 44, an analysis unit 60, a display 46, and a navigation processor 48.

The picked-up image receiver 44, as with the one thus far described, receives delivered information. Note that as mentioned above, the delivered information contains the identification number of the intersection camera which has delivered it. The analysis unit 60 extracts the part of a traffic signal from the reference image picked up by the reference image acquisition unit 40 and reads out the identification number by demodulating the blinking signal from the traffic signal. The description of the demodulation is omitted here, for it can be done using known art. The analysis unit 60 compares the identification information contained in the reference image against the identification information contained in the delivered information. If they are in agreement, the analysis unit 60 locates the intersection corresponding to the delivered information.

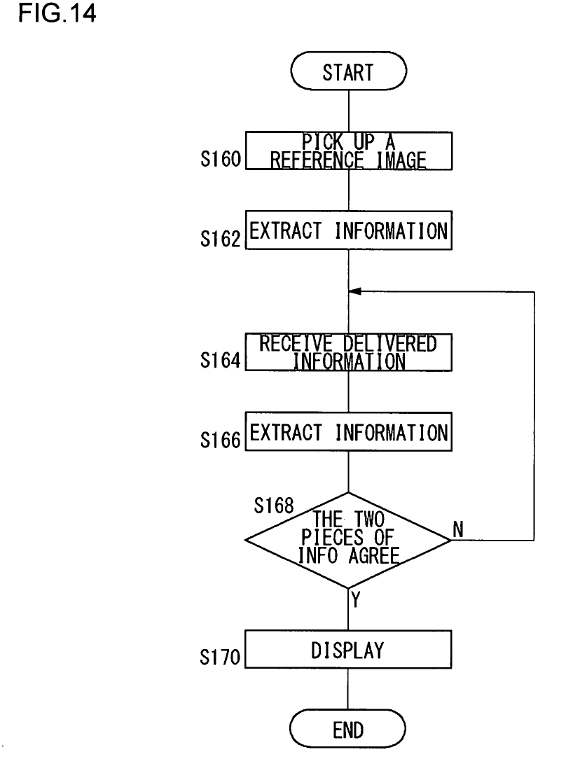

A description will now be given of an operation of the car navigation apparatus 12 implementing the structure as described above. FIG. 14 is a flowchart showing a display procedure for picked-up images by the car navigation apparatus 12. The reference image acquisition unit 40 acquires a reference image picked up by the on-vehicle camera 20 (S160). The analysis unit 60 extracts identification information contained in the reference image (S162). The picked-up image receiver 44 receives delivered information (S164). The analysis unit 60 extracts identification information from the delivered information (S166). If the analysis unit 60 finds an agreement between the identification information contained in the reference image and the identification information extracted from the delivered information (Y of S168), the display 46 will display picked-up images contained in the delivered information thus selected (S170). On the other hand, if the analysis unit 60 does not find an agreement between the identification information contained in the reference image and the identification information extracted from the delivered information (N of S168), a return will be made to Step 164.

In the another modification like this, there may be cases where a picked-up image taken by an intersection camera contains another traffic signal. In such a case, the intersection camera, the same way as with the car navigation apparatus 12, extracts the traffic signal picked up in the picked-up image and reads the identification information given by the traffic signal. The intersection camera also adds not only its own identification information but also the thus read identification information on the other traffic signals to the information to be delivered. And the intersection camera delivers the information. The car navigation apparatus 12, on the other hand, extracts a plurality of traffic signals contained in the reference image and reads the identification numbers corresponding thereto. The car navigation apparatus 12 also acquires identification information on a plurality of intersections contained in the delivered information and checks for an agreement between the identification numbers and the read identification numbers. And the car navigation apparatus 12 may locate an intersection based of the result of the checking.

Now a description will be given of still another modification of the present embodiment. In this still another modification, as with the exemplary embodiment, the intersection cameras deliver picked-up images as intersection information or delivered information, and the car navigation apparatus receives intersection information from each of a plurality of intersection cameras. Also, installed in the rear part of a vehicle is an on-vehicle camera for picking up rearview images, and the on-vehicle camera picks up a reference image. The car navigation apparatus locates specific intersection information by performing a pattern matching between the picked-up images contained in a plurality of intersection information and the reference image and displays the picked-up images contained in the intersection information thus located. Further, this still another embodiment assumes a case where there exists a large vehicle between a user's own vehicle and an intersection camera installed in the vehicle's direction of travel. The large vehicle herein may be a bus, a truck or the like.

Under such circumstances, the reference image may not contain the large vehicle, whereas the picked-up image may contain one. Also, since the area the large vehicle occupies in the picked-up image is normally significant, the pattern matching may more frequently end in a failure. In response to this situation, the present modification further includes (1) a processing to infer the presence of a large vehicle and (2) a processing to lower the failure rate of pattern matching due to the presence of a large vehicle, which will be explained hereinbelow.

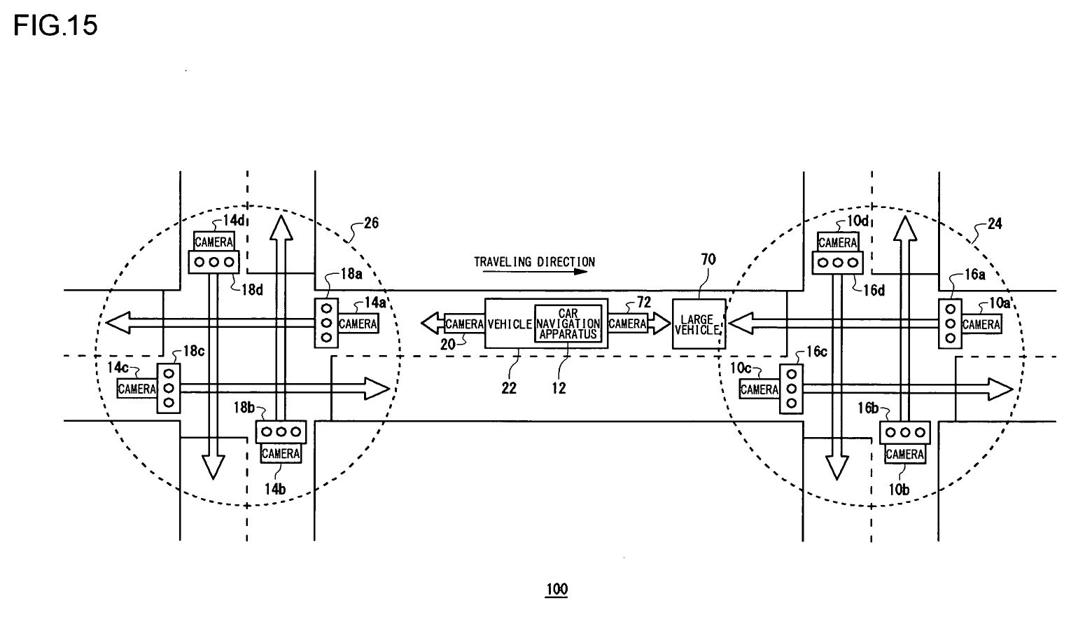

FIG. 15 shows a structure of a locating system 100 according to the still another modification of the exemplary embodiment. The locating system 100 shown in FIG. 15 has a large vehicle 70 and an on-vehicle camera 72 added to the structure shown in FIG. 1. Hence, the description of the parts identical to those in FIG. 1 is omitted in the following. As shown in FIG. 15, a large vehicle 70 is traveling at a location between the vehicle 22 and the intersection A 24, which is in the direction of travel of the vehicle 22. As a result, the picked-up image taken by the first intersection A camera 10a contains the large vehicle 70. Also, the large vehicle 70 is larger than the vehicle 22, and in addition it is closer to the first section A camera 10a than the vehicle 22, so that the area the large vehicle occupies in the picked-up image can be significant. On the other hand, the reference image taken by the on-vehicle camera 20 does not contain the large vehicle 70. As a result, a pattern matching between the picked-up image and the reference image, which are both taken in the same direction, may end in a failure due to the presence of the large vehicle 70.

To cope with this problem, the vehicle 22 is provided with an on-vehicle camera 72 to capture a reference image in the direction of travel (hereinafter referred to a “forward reference image”). The car navigation apparatus 12 decides whether there is any large vehicle forward, based on the forward reference image. The processing used in this decision is equal to the aforementioned processing (1). If there is no large vehicle present, the car navigation apparatus 12 locates the intersection A 24 the same way as in the exemplary embodiment. On the other hand, if there is a large vehicle present, the car navigation apparatus 12 locates the intersection A 24 by a processing different from the exemplary embodiments. The processing used in this locating is equal to the aforementioned processing (2). Note that the intersection A cameras 10 according to this still another modification are of the same type as one shown in FIG. 2 and the car navigation apparatus 12 according to this still another modification is of the same type as one shown in FIG. 3.

First, the processing of (1) will be explained. The reference image acquisition unit 40 of the car navigation apparatus 12 acquires a forward reference image. The matching processor 42 derives the ratio of pixel values within a predetermined range to the forward reference image. The matching processor 42 acquires a pixel value on predetermined coordinates of the reference image. The predetermined coordinates are, for instance, the coordinates of the center of a reference image. The matching processor 42 also sets a predetermined range in such a manner that the above-mentioned pixel value becomes the median thereof. Further, the matching processor 42 calculates the number of coordinates within a predetermined range within the forward reference image and derives the ratio of the pixel values within the predetermined range to the forward reference image based on the result of the calculation. Note that the predetermined coordinates may be present in a plurality of separate positions, and in such a case the above-described processing is carried out in parallel with each other.

The matching processor 42 compares the derived ratio with a threshold value and deduces the presence of a large vehicle forward if the ratio is greater than or equal to the threshold value. For example, when there is a large vehicle, such as a truck, forward, it is expected that the ratio of the truck occupying the forward reference image is rather significant. And if the coating on the truck is substantially even, then it is expected that the pixel values thereof will be within a certain area in the forward reference image. These conditions are assumed in this processing. The predetermined area and the threshold value may be predetermined by experiment or the like.

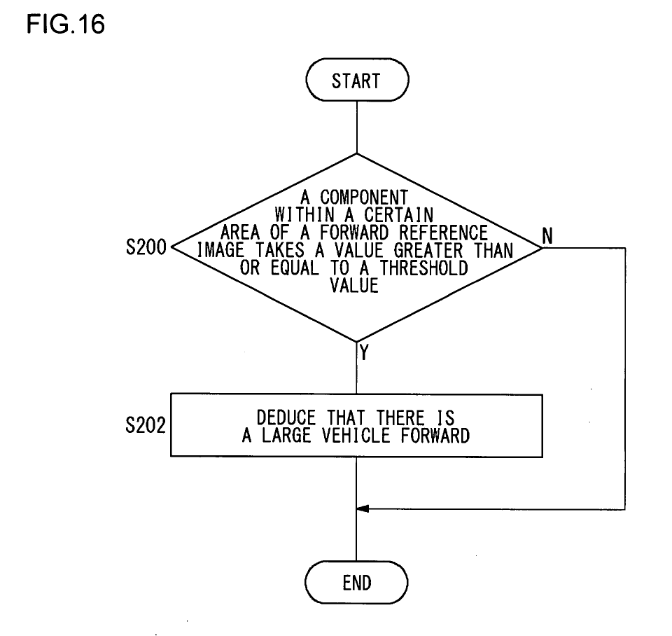

FIG. 16 is a flowchart showing a deduction procedure for the presence of a large vehicle according to this still another modification of the exemplary embodiment. If a certain area in the forward reference image takes a value greater than or equal to the threshold value (Y of S200), the matching processor 42 deduces that there is a large vehicle forward (S202). On the other hand, if the certain area in the forward reference image does not take a value greater than or equal to the threshold value (N of S200), the matching processor 42 ends the processing.

Next, the processing of (2) will be explained. After deducing the presence of a large vehicle forward, the matching processor 42 performs a pattern matching between each of the plurality of picked-up images and a reference image the same way as in the exemplary embodiment. However, as already stated, a large vehicle is contained only in a picked-up image that is to be matched, so that the picked-up image presents a greater difference from the reference image than the picked-up images that do not contain the large vehicle. Thus, the matching processor 42 excludes a middle part of the images from the pattern matching. That is, pattern matching is done on the parts of the images other than the middle part where the large vehicle is more likely to be contained.

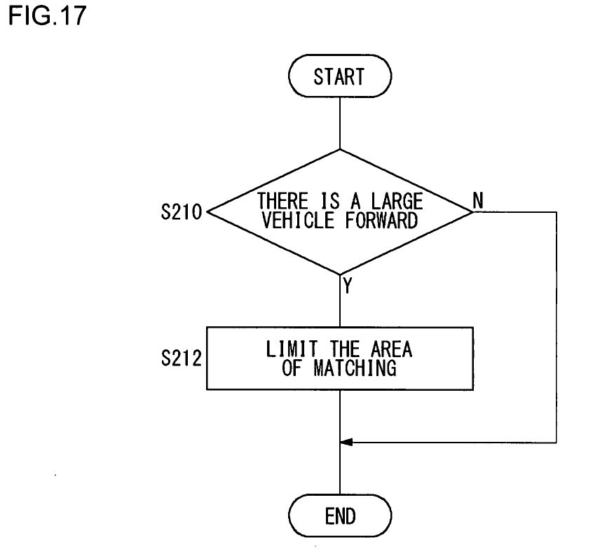

FIG. 17 is a flowchart showing a display procedure for picked-up images according to still another modification of the exemplary embodiment. If there is a large vehicle forward (Y of S210), the matching processor 42 will limit the area of matching (S212). On the other hand, if there is no large vehicle forward (N of S210), the matching processor 42 will end the processing. Note that the part of the picked-up images and the reference image to be excluded is not limited to the middle part thereof. Any part of the picked-up images and the reference image may be excluded from pattern matching as long as it is part thereof where a large vehicle is more likely to be contained.

Another version of (2) will now be explained. When it is deduced that there is a large vehicle forward, the matching processor 42 does not use the reference image as in the exemplary embodiment. The matching processor 42 identifies the vehicle number of the large truck contained in the forward reference image by performing a character recognition processing on the forward reference image. The description of the character recognition processing is omitted here, for it can be done using known art. The matching processor 42 also extracts the vehicle number by performing a character recognition processing on each of the plurality of picked-up images. Thus the matching processor 42 locates the intersection A 24 when the vehicle number identified in the forward reference image is among the plurality of the picked-up images.

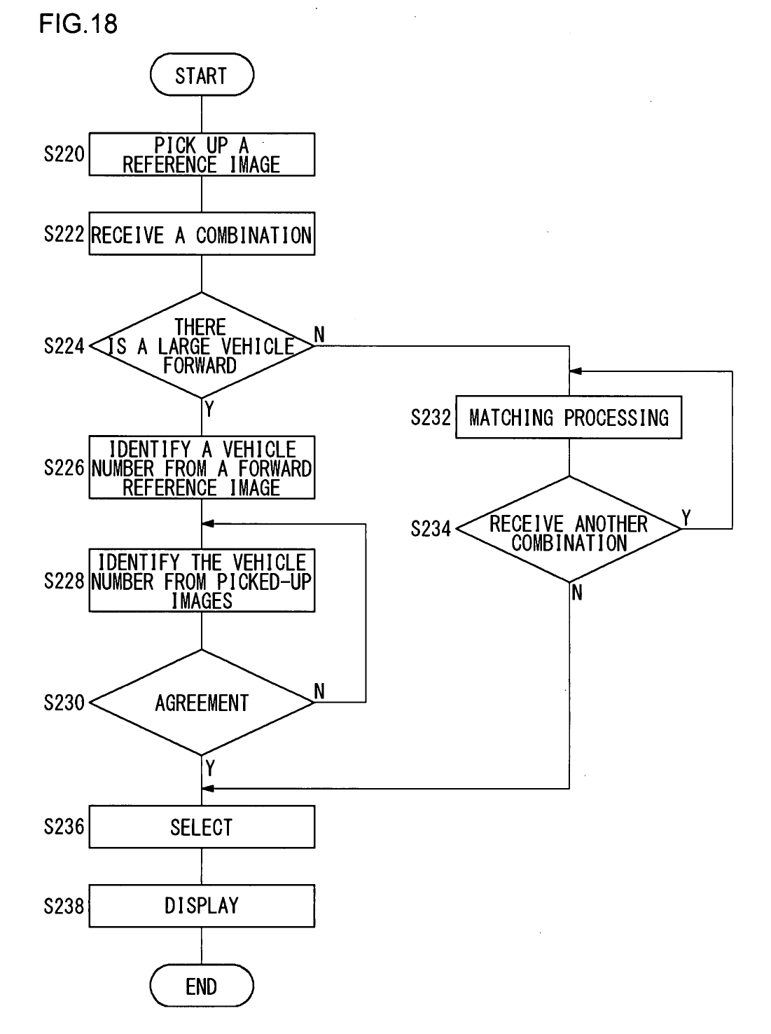

FIG. 18 is a flowchart showing a display procedure for picked-up images according to this still another modification of the exemplary embodiment. The reference image acquisition unit 40 acquires a forward reference image, which is a reference image picked up by the on-vehicle camera 20 (S220). The picked-up image receiver 44 receives a combination of picked-up images (S222). If there is a large vehicle forward (Y of S224), the matching processor 42 identifies a vehicle number from forward reference image (S226). The matching processor 42 also identifies a vehicle number from the picked-up images (S228). If there is no agreement between the vehicle number in the forward reference image and that from the picked-up images (N of S230), the matching processor 42 returns to Step 228. On the other hand, if there is an agreement between the vehicle number in the forward reference image and that from the picked-up images (Y of S230), the matching processor 42 selects one combination of images (S236).

If there is not any large vehicle forward (N of S224), the matching processor 42 will perform a pattern matching processing on the combination of picked-up images and the reference signal (S232). If the picked-up image receiver 44 receives any other combination of images (Y of S234), a return will be made to Step 232. If the picked-up image receiver 44 does not receive any other combination of images (N of S234), the matching processor 42 will select a combination of images based on the result of the pattern matching processing (S236). The display 46 displays the picked-up images contained in the selected combination (S238).

According to the exemplary embodiments of the present invention, an intersection is located by a pattern matching between picked-up images and a reference image, so that the up-to-the-moment information can be used and therefore an intersection can be located accurately. Also, a pattern matching is used, so that predetermined locations on the road, such as intersections, can be located with accuracy without relying on the memory of road information. Further, the pattern matching enables accurate locating of an intersection without any image pickup of the user's own vehicle. Also, the use of a picked-up image taken in the direction of the vehicle from an intersection enables the image pickup of the vicinity of the vehicle and, besides, the short distance from the intersection to the vehicle enhances the accuracy of pattern matching. Further, the use of a picked-up image taken in the direction of the intersection of interest from an intersection adjacent to it enables the image pickup of the vehicle and, besides, the short distance from the intersection to the vehicle enhances the accuracy of pattern matching. Also, information on an intersection can be communicated to a vehicle's driver. Moreover, an intersection is located based on the identification information contained in delivered information and the identification information extracted from a picked-up reference image, so that an intersection can be located with accuracy without relying on the memory of road information.

The locating of intersections using identification information provided to each of a plurality of intersections achieves an improved accuracy of location. Further, the presence of a large vehicle is deduced based on the ratio of the pixel values within an identical area occupying a forward reference image, so that the deduction can be carried out easily. When there is a large vehicle, the area of an image where the large vehicle is likely to be present is excluded from the pattern matching, so that the accuracy of the pattern matching can be improved. When there is a large vehicle, matching is performed using the vehicle numbers contained in the forward reference image and the picked-up images, so that the accuracy of the matching can be improved.

The description of the invention given above is based upon illustrative embodiments. These embodiments are intended to be illustrative only and it will be obvious to those skilled in the art that various other modifications to constituting elements and processes could be developed and that such modifications are also within the scope of the present invention.

In the exemplary embodiment of the present invention, the traffic signals, such as the intersection A signals 16 and the intersection B signals 18, transmit lighting signals which are modulated according to their respective identification information. However, the exemplary embodiments of the present invention are not limited to such an arrangement. For example, lamps, such as LEDs, may be installed at the traffic signals, such as the intersection A signals 16 and the intersection B signals 18. The car navigation apparatus 12 locates an intersection if it finds an agreement between the color of the LED lamp picked up in the reference image and the color information of the LED lamp contained in the delivered information. At this time, the display 46 may display the color because the color of an LED can be directly checked by the eyes of the driver. According to this modification, it is not necessary to modulate the lighting signals, so that the processing can be made simpler. Also, the intersection A cameras 10 may add the present color of the traffic signal, not the identification information thereof, to the information to be delivered, and the car navigation apparatus 12 may locate the intersection if there is an agreement between the color of the traffic signal contained in the reference image and the color information of the signal contained in the delivered information. This modification allows the use of a simpler structure of the system.

In an exemplary embodiment of the present invention, the car navigation apparatus 12 uses a reference image picked up by an on-vehicle camera 20. The exemplary embodiments of the present invention, however, are not limited to such an arrangement, and the car navigation apparatus 12 may store reference images in advance. The matching processor 42 stores in advance images of forward views or rearward views of the vehicle 22 as reference images. The reference images meant here are images containing objects of interest picked up by the intersection A cameras 10 or the intersection B cameras 14, which provide feature data of colors, shapes and the like of subjects to be displayed. These reference images, which the user cannot set on his/her own, are already set before the shipment of the car navigation apparatuses 12. Therefore, the reference images may show the rear part or the front part of the vehicle 22, but not the background.

The matching processor 42 decides whether a reference image is among the picked-up images or not by performing pattern matching between the picked-up images contained in the delivered information and a reference image stored in advance. A case of a reference image being among the picked-up images is, for instance, a case where the rear part of the vehicle 22 is contained in a picked-up image. If a reference image is among the picked-up images, the matching processor 42 will carry out a processing such that changes occur in the picked-up images newly taken by the intersection A cameras 10 or the intersection B cameras 14. Here, a processing that causes changes to occur in the newly picked-up images is a processing that causes visual changes in the finally picked-up images. Here, the matching processor 42 instructs, via a not-shown communication unit, the intersection A cameras 10 or the intersection B cameras 14 to carry out a processing that causes changes in the picked-up images.

For example, included in such instructions may be a change in vertical tilt angle of the intersection A cameras 10 or the intersection B cameras 14, a panning to change the horizontal (right and left) direction thereof, or a zoom change by changing the magnification of the image pickup unit 36 thereof. That is, the instructions have to do with the manipulation of the intersection A cameras 10 or the intersection B cameras 14. The matching processor 42 transmits these instructions as instruction signals to the intersection A cameras 10 or the intersection B cameras 14.

While the matching processor 42 is giving these instructions, the picked-up image receiver 44 receives newly picked-up images from the intersection A cameras 10 and/or the intersection B cameras 14. The matching processor 42 checks to see whether or not the changes in response to the instructions are taking place in the newly picked-up images received. For example, if the instructions have been for a change of the direction of the intersection A cameras 10 or the intersection B cameras 14 downward, the parts of the reference image contained in the picked-up images must shift relatively upward. Accordingly, if the feature points in the reference image extracted by the matching processor 42 exist in upper positions in the image than those in the already extracted picked-up images, then the matching processor 42 will conclude that the changes as instructed are now taking place in the newly picked-up images received. According to the this modification, the car navigation apparatus 12 locates the desired intersection A cameras 10 in two stages of decision-making, so that the accuracy of location can be improved.

It is to be noted that the car navigation apparatus 12 may locate the desired intersection A cameras 10 by an initial decision only without performing the two stages of decision-making. In such a case, if the user's own vehicle is picked up in a plurality of images, the car navigation apparatus 12 will select a picked-up image in which his/her own vehicle is the largest. This modification can make the processing simpler.

In an exemplary embodiment of the present invention, information is delivered after the first intersection A camera 10a or the like has gathered a plurality of picked-up images. The exemplary embodiments of the present invention, however, are not limited to such an arrangement. For example, a transmitter connected to the four intersection A cameras 10 may be provided, and the information may be delivered after this transmitter has gathered a plurality of picked-up images. Also, the four intersection A cameras 10 may deliver their respective picked-up images. Or the information may be delivered after the four intersection A cameras have gathered their respective picked-up images.

In an exemplary embodiment of the present invention, the first intersection A camera 10a, for instance, delivers information containing a combination of picked-up images upon completion of the combination at Step 74 in FIG. 8. The exemplary embodiments of the present invention, however, are not limited to such an arrangement. For example, the first intersection A camera 10a may deliver information containing a combination of picked-up images even when the combination is not completed. In such a case, the first intersection A camera 10a includes in the information to be delivered a message about the absence of a picked-up image or images. For example, an image of a single color, such as black, may be included, or the content of an image may be indicated as “NULL”. Or the first intersection A camera 10a may define a predetermined period of time and may deliver information only when the predetermined period of time has passed since the latest delivery of information. According to this modification, provision of information on even one of the combination of images, e.g., information for a right turn only, may assist the vehicle's driver more than when there is none. Even when there are no picked-up images from intersection A cameras 10 other than the first intersection A camera 10a, the delivery of the picked-up image from the first intersection A camera 10a can warn the vehicle's driver by giving a message which reads: “Drive carefully because right turn or left turn information at the next intersection A 24 is not delivered at present”.

In an exemplary embodiment of the present invention, the car navigation apparatus 12, for instance, selects one combination of picked-up images at Step 98 in FIG. 9. The exemplary embodiments of the present invention, however, are not limited to such an arrangement. For example, the matching processor 42 may not make a selection based on the result of comparing the matching result against the threshold value. For instance, if the reliability of the matching result is 50% or above, the display 46 will display the picked-up image together with the reliability. Otherwise, however, the display 46 does not display. In such a case, it is preferable that the display 46 may display picked-up images according to the instructions from the vehicle's driver. This modification can improve the reliability level of selections.

While the preferred embodiments of the present invention have been described using specific terms, such description is for illustrative purposes only, and it is to be understood that changes and variations may be further made without departing from the spirit or scope of the appended claims.

What is claimed is:

1. A locating apparatus, comprising:
a receiver which receives a plurality of picked-up images taken by image pickup apparatuses provided in a plurality of positions on a road, respectively, via a wireless network;
an acquisition unit which acquires a reference image to be compared respectively with the plurality of picked-up images received by said receiver, the reference image having been taken by an image pickup apparatus installed in a vehicle; and
a selector which performs pattern matching between the reference image acquired by said acquisition unit and each of the plurality of picked-up images received by said receiver so as to locate at least one position on the road.

2. A locating apparatus according to claim 1, wherein said receiver receives a plurality of picked-up images taken by image pickup apparatuses provided at a plurality of intersections, respectively, wherein the plurality of intersections corresponds to the plurality of positions on the road,
wherein said acquisition unit acquires the reference image from an image pickup apparatus for taking a rearward image from the vehicle, said image pickup apparatus corresponding to the image pickup apparatus installed in the vehicle, and
wherein said selector performs pattern matching between a picked-up image of a view from the intersection in a direction of the vehicle out of the plurality of picked-up images and the reference image.

3. A locating apparatus according to claim 1, wherein a plurality of intersections corresponds to the plurality of positions on the road, and said receiver receives a combination of a picked-up image taken by an image pickup apparatus provided at a first intersection and a picked-up image taken by an image pickup apparatus provided at a second intersection adjacent to the first intersection,
wherein said acquisition unit acquires a reference image from an image pickup apparatus for taking a forward image from the vehicle, said image pickup apparatus corresponding to the image pickup apparatus installed in the vehicle, and
wherein said selector performs pattern matching between a picked-up image of a view in a direction from the second intersection toward the first intersection in the combination and the reference image so as to locate the first intersection.

4. A locating apparatus according to claim 1, further comprising a storage which stores an image of the vehicle in which said locating apparatus is provided,
wherein said acquisition unit acquires the reference image stored in said storage.

5. A locating apparatus according to claim 2, further comprising a display which displays a picked-up image in the intersection located by said selector.

6. A locating apparatus, comprising:
a receiver which receives a plurality of picked-up images taken by image pickup apparatuses provided in a plurality of positions on a road, respectively, via a wireless network;
an acquisition unit which acquires a reference image to be compared respectively with the plurality of picked-up images received by said receiver, the reference image having been taken by an image pickup apparatus installed in a vehicle; and
a selector which locates at least one position on the road, based on information contained in the reference image acquired by said acquisition unit and information associated with each of the plurality of picked-up images received by said receiver.

7. A locating method in which a plurality of picked-up images taken by image pickup apparatuses provided in a plurality of positions on a road, respectively, are received via a wireless network, a reference image taken by an image pickup apparatus installed in a vehicle is acquired, and pattern matching is performed between each of the plurality of picked-up images and the reference so as to locate at least one position on the road.

8. A locating method in which a plurality of picked-up images taken by image pickup apparatuses provided in a plurality of positions on a road, respectively, are received via a wireless network, a reference image taken by an image pickup apparatus installed in a vehicle is acquired, and at least one position on the road is located, based on information associated with each of the plurality of picked-up images and information contained in the reference image.
